(19) United States
(12) Patent Application Publication
(10) Pub. No.: US 2026/0350324 A1
(43) Pub. Date: Nov. 5, 2026

(54) BIDIRECTIONAL REAL-TIME SPEECH TRANSLATION USING PROMPT-OPTIMIZED SPEECH-TO-SPEECH GENERATIVE LANGUAGE MODELS

(71) Applicant: Twilio Inc., San Francisco, CA (US)

(72) Inventors: Gunjan Gupta, San Francisco, CA (US); Doa Jafri, San Francisco, CA (US); Kousha Talebian, San Francisco, CA (US); Noah Cooper, San Francisco, CA (US); Jeffrey Marc Eiden, San Francisco, CA (US)

(21) Appl. No.: 19/194,445

(22) Filed: Apr. 30, 2025

(51) Int. Cl. G06F 40/58; G06F 40/174; G06F 40/186; G10L 15/00; G10L 15/30; H04M 3/42; H04M 7/00

(52) U.S. Cl. CPC G06F 40/58; G06F 40/174; G06F 40/186; G10L 15/005; G10L 15/30; H04M 3/42153; H04M 7/006; H04M 2203/2061

(57) ABSTRACT

A communications application—in some embodiments, implemented via cloud-computing resources—enables real-time bidirectional speech translation between users speaking different languages through specialized prompting mechanisms and optimized audio stream processing. The application orchestrates integration of voice channels and speech-to-speech generative language models while providing intelligent routing based on language detection and customer profiles. The system employs carefully engineered prompts to ensure pure translation rather than interpretation, overcoming the natural tendency of language models to generate responsive outputs. Through WebSocket connections and parallel audio stream management, the application maintains low latency while preserving conversation quality. The architecture incorporates automated language detection, confidence scoring, and contextual analysis to enhance translation accuracy and enable seamless switching between languages during conversations.

### TECHNICAL FIELD

The present application pertains to the technical field of cloud-based communication applications that enable real-time voice translation using speech-to-speech generative language models and telephony networks. More specifically, the innovations described herein relate to a middleware communications application that orchestrates low-latency bidirectional speech-to-speech translation between participants speaking different languages through specialized prompting mechanisms, context-aware routing, and optimized audio stream processing. The cloud-based, middleware application provides seamless integration of voice channels, media streams, and speech-to-speech generative language models to achieve real-time translation with significantly reduced latency compared to conventional approaches, while maintaining translation accuracy through precise prompt engineering and dynamic prompt updates that ensure pure translation rather than interpretation. The architecture of the application enables intelligent routing based on language detection, customer profiles, and historical data, while supporting deployment across various communication channels including public switched telephone networks (PSTN) and programmable voice platforms. The system further incorporates real-time confidence scoring, text logging capabilities, and contextual analysis to enhance translation quality and enable post-call analytics.

### BACKGROUND

The field of natural language processing (NLP) has undergone a transformative evolution in recent years, driven by advancements in artificial intelligence (AI) and machine learning. One of the most significant developments within this field is the emergence of generative language models capable of understanding and producing human-like text. These models, such as the Transformer-based architectures, have demonstrated unprecedented capabilities in a range of tasks, from text generation and summarization to question answering and translation. Leveraging massive datasets and advanced training techniques, these models can generate outputs that exhibit remarkable fluency and coherence.

Building on the success of text-based generative language models, researchers have extended these capabilities to include multimodal inputs and outputs. Among these advancements is the advent of speech-to-speech generative language models. Unlike traditional models that separately process speech recognition and synthesis as distinct steps, these integrated systems can receive spoken language as input, process it using language modeling techniques, and produce spoken language as output. This holistic approach eliminates the need for intermediate text representations, enabling more seamless and context-aware language transformations.

### BRIEF DESCRIPTION OF THE DRAWINGS

Embodiments of the present invention are illustrated by way of example and not limitation in the figures of the accompanying drawings, in which:

FIG. 1 illustrates a technical limitation inherent in speech-to-speech generative language models, showing how these models naturally generate outputs that are responsive to the input prompt, rather than performing direct translation.

FIG. 2 illustrates, in accordance with some embodiments, a cloud-based communication platform architecture integrating voice services, messaging services, and AI/machine learning capabilities with an AI and model service provider for speech-to-speech translation.

FIG. 3 illustrates a cloud-based communications application that orchestrates real-time speech translation through specialized components including call management services, speech translation capabilities, and data integration features, consistent with some embodiments.

FIG. 4 illustrates, in accordance with some embodiments, a sequence diagram showing the interaction flow between end-user devices, a communications application, and AI model providers for establishing and managing real-time translated conversations between users speaking different languages.

FIG. 5 illustrates, in accordance with some embodiments, a software architecture diagram showing various application layers, frameworks, and system components that support the cloud-based translation platform.

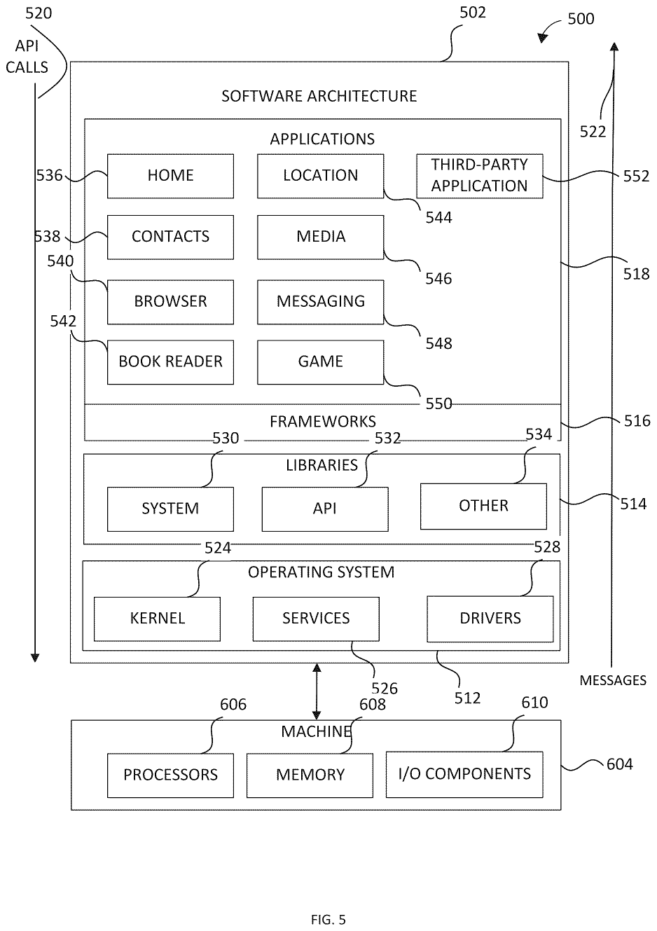

FIG. 6 illustrates, in accordance with some embodiments, a detailed diagram of machine architecture components including processors, memory systems, and I/O components that enable the execution of the cloud-based translation platform.

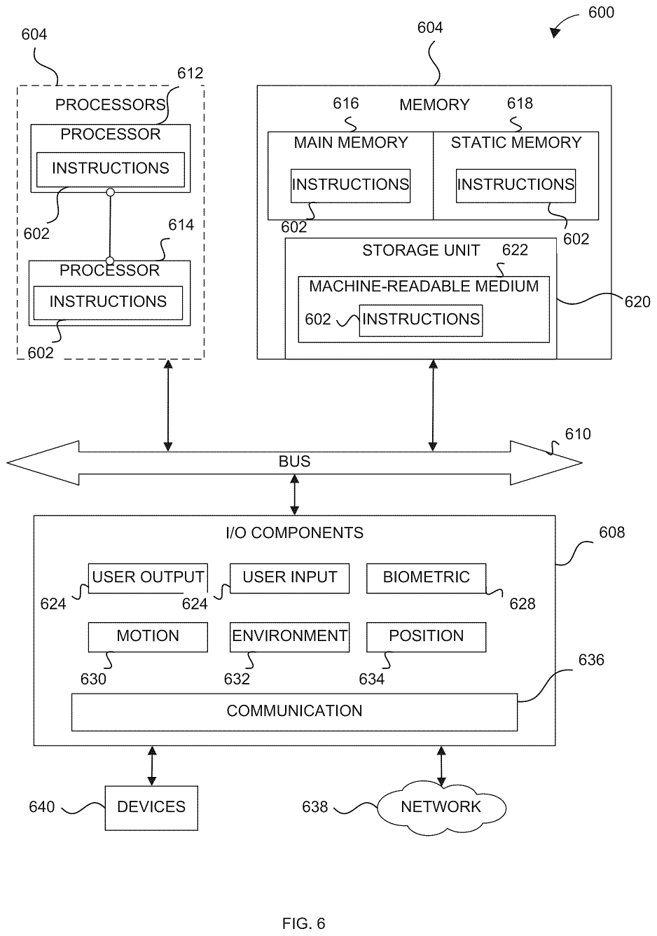

### DETAILED DESCRIPTION

Described herein are techniques for implementing a cloud-based middleware, communications application that enables real-time bidirectional speech translation using speech-to-speech generative language models, such as large language models (LLMs). The communications application orchestrates the integration of voice channels, media streams, and translation services while providing intelligent routing capabilities based on language detection, customer profiles, and historical data. The system employs specialized prompting mechanisms with dynamic template updates and language-specific examples to ensure pure translation rather than interpretation, while managing parallel audio streams through bi-directional real-time communications connections, such as WebSocket connections. The communications application coordinates real-time processing of voice streams across public switched telephone networks (PSTN) and programmable voice platforms, enabling automated language translation without requiring specialized software in use at the endpoints. The communications application incorporates features including mid-conversation language detection and switching, confidence scoring, text logging for post-call analytics, and contextual routing based on factors such as time zones and agent availability. In the following description, numerous specific implementation details are provided to enable a thorough understanding of the various aspects and embodiments, including techniques for establishing translation sessions, methods for optimizing latency through prompt engineering, and approaches for managing real-time voice translation in contact center environments. It will be apparent to one skilled in the art, however, that these techniques may be practiced in many different forms and that various modifications and alterations may be made without departing from the broader spirit and scope of the innovations described herein.

Traditional human-based translation systems for real-time communications face significant limitations in scalability, consistency, and availability. Human interpreters, while capable of high-quality translation, introduce substantial costs and logistical challenges for organizations needing 24/7 multilingual support. Additionally, human translation services often require advance scheduling and cannot easily accommodate spontaneous or emergency communication needs.

Conventional automated translation systems that pre-date generative language models, such as LLMs, typically relied on a multi-step process: converting speech to text, translating the text, and then converting the translated text back to speech. This approach introduced significant latency issues and often resulted in disjointed, unnatural conversations. These systems struggled with context preservation and frequently produced literal translations that failed to capture nuanced meanings or cultural contexts.

For example, when a Hindi-speaking caller says

[symbol]

(which literally translates to “I understood your words”), the conventional system would perform a rigid word-by-word translation, potentially missing the more natural English equivalent of simply saying “I understand.” Similarly, common Hindi phrases like [symbol]
(literally “how are you existing?”) would be translated mechanically rather than converting to the natural English greeting “how are you?” These literal translations not only sound unnatural but can create confusion and miscommunication between parties. The conventional systems lacked the contextual awareness to recognize that these are common conversational phrases that have equivalent expressions in the target language, instead producing awkward literal translations that disrupted the natural flow of conversation. This technical limitation became particularly problematic in customer service scenarios where clear, natural communication is essential for resolving issues effectively.

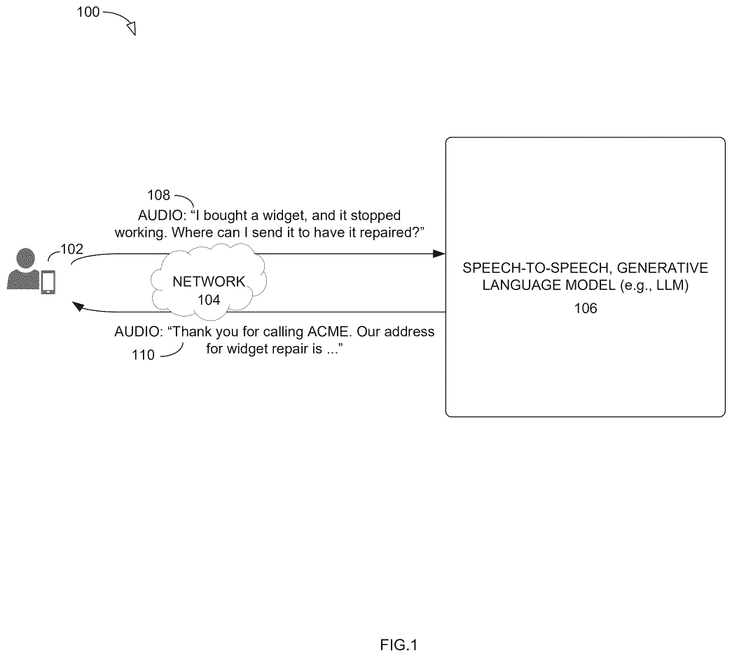

While speech-to-speech LLMs represent a breakthrough in direct voice translation capabilities, implementing them effectively as a translation mechanism presents several technical challenges. One primary challenge is that these models are typically trained to generate interpretive responses to queries rather than perform pure translation. This results in the models attempting to answer or interpret input rather than maintaining fidelity to the original speaker's words. This technical limitation is illustrated in FIG. 1, which demonstrates how speech-to-speech language models naturally process input speech as queries requiring responses rather than content for direct translation.

FIG. 1 illustrates a technical limitation inherent in speech-to-speech language models, showing a user with a mobile device 102 communicating through a network 104 with a speech-to-speech, generative language model 106. The illustration demonstrates how the model 106 processes audio input, where a user provides speech input 108 asking, “I bought a widget, and it stopped working. Where can I send it to have it repaired?” Rather than translating this input to another language, the model 106 generates a responsive audio output 110 stating, “Thank you for calling ACME. Our address for widget repair is . . . ” This interaction exemplifies how the model 106 defaults, based on its training, to interpreting the semantic meaning of the input and generating a contextual response, rather than performing direct language-to-language translation. Based on how the model has been trained, the model has a natural tendency toward interpretation, rather than translation.

Additional technical challenges include managing real-time bidirectional audio streams while maintaining low latency, handling mid-conversation language switches, and integrating with existing telephony infrastructure. The system must also balance the need for immediate translation with maintaining accuracy and context awareness. Traditional approaches to these challenges often resulted in systems that either sacrificed translation quality for speed or introduced unacceptable delays in conversation flow.

Furthermore, conventional systems typically lack the ability to maintain contextual awareness across a conversation or leverage historical interaction data to improve translation quality. They often struggle with dynamic language detection and automatic switching between language pairs, requiring manual configuration and lacking the flexibility needed for natural multilingual communication.

Consistent with some embodiments, described herein is a cloud-based middleware communications application that solves multiple technical challenges in real-time speech translation by implementing an architecture with specialized components and novel processing techniques. The communications application employs carefully engineered prompting mechanisms that overcome the natural tendency of speech-to-speech generative language models to generate interpretive responses rather than pure translations. This is achieved through dynamic prompt templates, language-specific examples, and periodic prompt refreshing to maintain translation mode.

The system architecture integrates call management components, voice response logic, and WebSocket connection managers to handle real-time bidirectional audio streams while maintaining low latency. The communications application incorporates automated language detection and switching capabilities that eliminate the need for manual configuration, allowing natural conversation flow even when participants change languages mid-conversation. This is accomplished through continuous monitoring of confidence scores and error rates to trigger language model switching when needed.

To address the contextual awareness limitations of conventional systems, the communications application implements sophisticated data integration components that leverage customer profiles, historical interaction data, and real-time conversation context. This enables intelligent routing based on factors such as time zones, agent availability, and language capabilities, when implemented in contexts such as contact center or call center services. The system maintains contextual awareness through logging and analytics components that capture both audio streams and text transcripts, enabling post-call analysis while preserving conversation quality.

The architecture provides seamless integration with existing telephony infrastructure through a modular design that separates call management, translation services, and model integration. This allows deployment across various communication channels including PSTN and programmable voice platforms without requiring specialized endpoint software. The system, in some embodiments, includes a WebSocket connection manager that ensures reliable real-time communication between the communications application and speech-to-speech generative language models while maintaining optimal latency for natural conversation flow.

Through this comprehensive approach, various embodiments solve the core technical challenges of real-time speech translation while providing a flexible, scalable platform that can adapt to different use cases and deployment scenarios. The system maintains high translation quality and natural conversation flow while eliminating the need for human interpreters or manual language configuration. Other aspects and advantages of the various embodiments will be readily apparent from the detailed descriptions of the several figures that follows.

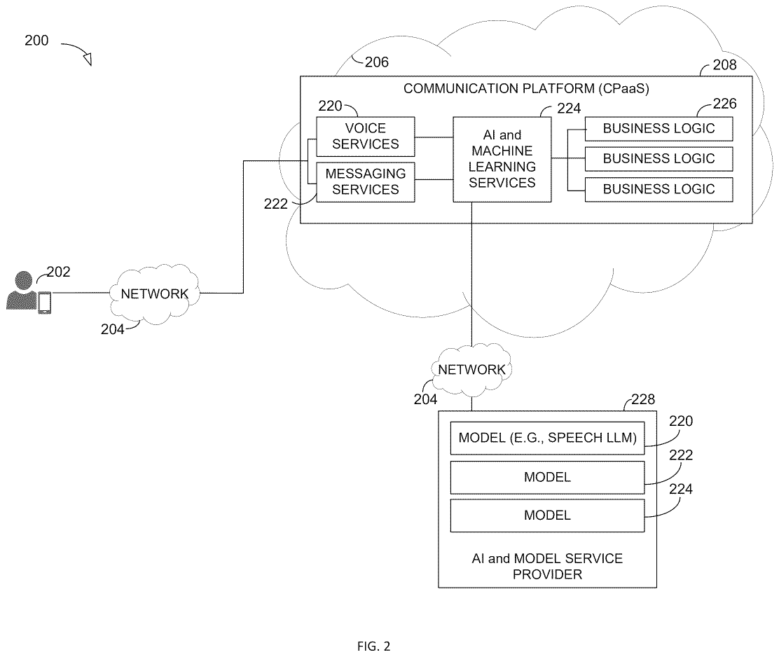

FIG. 2 illustrates a cloud-based communications platform 206 (CPaaS) that enables real-time language translation through integration of voice services 220, messaging services 222, and AI/machine learning capabilities 224. The platform 206 provides the primary infrastructure for implementing the specialized communications application that orchestrates real-time translation services while maintaining contextual awareness and intelligent routing capabilities.

Consistent with some embodiments, the communication platform 206 operates within a cloud computing environment and provides configurable translation services through its integrated components. The platform includes voice services 220 for processing real-time audio streams, messaging services 222 for handling text-based interactions, and AI/machine learning services 224 that can be configured through business logic 226 to enable specialized prompting mechanisms that ensure pure translation rather than interpretation.

The platform 206 enables deployment of middleware applications that serve multiple participants through intelligent routing and translation services. A user device 202 connects to the platform through network 204, where the middleware communications application orchestrates real-time translation sessions using specialized prompting and audio stream management. The application leverages the platform's voice services 220 and AI capabilities 224 while implementing custom business logic 226 that handles language detection, context management, and dynamic prompt updates.

The business logic components 226 enable sophisticated translation workflows through the platform 206. The middleware communications application configures these components to implement specialized prompting mechanisms, manage parallel audio streams, and coordinate with speech-to-speech language models hosted by an AI and model service provider 228.

The AI and model service provider 228 hosts multiple models including speech-to-speech generative language model 220, and other specialized models 222, 224 that are accessed through WebSocket connections managed by the communications application. This architecture enables real-time translation while maintaining low latency through optimized audio stream processing and specialized prompt engineering that ensures accurate translation.

User devices 202 communicate with the platform 206 over networks 204, which may include PSTN, VoIP networks, or other telecommunications infrastructure. The platform supports various connection types including WebSocket connections for real-time media streaming and traditional telephony protocols, enabling broad accessibility without requiring specialized endpoint software.

The platform 206 coordinates processing through integration of its core services:
Voice services 220 manage real-time audio processing
Messaging services 222 handle text-based interactions and logging
AI/ML services 224 coordinate with business logic 226 to maintain translation accuracy and context awareness

The network connections 204 facilitate real-time communication between user devices 202, the platform 208, and the AI model service provider 228. This architecture enables low-latency processing while maintaining separate translation streams for each language pair through WebSocket connections. The system provides comprehensive real-time translation capabilities by coordinating cloud-based services, AI capabilities, and specialized translation models while preserving conversation quality and context.

Consistent with some embodiments, the cloud-based communications platform 208 provides comprehensive telephony services through integration of traditional telecommunications infrastructure with modern internet-based technologies. The platform 208 enables provisioning and management of telephone numbers that can be configured for specialized translation services through programmable voice and messaging capabilities.

The telephony services support multiple communication channels, including local, toll-free, and international telephone numbers that can be programmatically configured. Integration with Public Switched Telephone Network (PSTN) ensures compatibility with conventional telephones, while Voice over IP (VoIP) capabilities enable internet-based protocols. Consistent with some embodiments, the platform 208 also supports Session Initiation Protocol (SIP) trunking for enterprise voice system integration and WebRTC support for browser-based communications.

Consistent with some embodiments, the platform 208 incorporates call management capabilities through cloud-based, interactive voice response (IVR) services for automated language selection and user interaction, programmable call routing based on language capabilities and availability, real-time media streaming through secure WebSocket connections, and support for multiple audio codecs and transcoding between formats.

Advanced integration features are enabled through Application Programming Interfaces (APIs) for custom functionality development, Software Development Kits (SDKs) for implementation of translation services, integration with customer relationship management (CRM) systems, and connection to third-party AI and machine learning services.

The platform provides comprehensive monitoring and analytics capabilities including real-time performance tracking of voice and messaging services, call quality metrics and latency monitoring, usage analytics and reporting, and system health and availability monitoring.

The architecture supports global scalability through distributed cloud infrastructure, multiple points of presence for reduced latency, redundant network connections, and load balancing and failover capabilities. Security features include encrypted media transport using SRTP protocols, secure WebSocket (WSS) connections, authentication and access control mechanisms, and compliance with telecommunications regulations and standards.

Consistent with some embodiments, the communications application may be offered as a service to business customers of the enterprise that provides the communications platform 208. Multiple instances of the communications application can be deployed simultaneously, with each instance dedicated to and isolated for a specific business customer's use. This multi-tenant architecture enables secure and independent operation of translation services for different organizations while leveraging the shared infrastructure of the communications platform.

The communications application is highly customizable to accommodate specific business requirements and use cases. Business customers can configure various aspects of the application including: language pair selections, prompt templates and examples for different contexts, confidence score thresholds for language detection and switching, routing logic based on time zones and agent availability, and integration parameters for customer profile data and historical analytics. Additionally, customers can select specific AI and model service providers and configure which speech-to-speech models are used for different language pairs or use cases.

Configurable elements of the communications application may include, but are not limited to:
Language detection parameters and thresholds
Prompt templates and language-specific examples
WebSocket connection parameters and audio stream quality settings
Integration settings for customer profile data and CRM systems
Routing rules based on agent language capabilities and availability
Confidence score thresholds for translation quality monitoring
Text logging and analytics preferences
Selection of specific speech-to-speech models for different language pairs
IVR prompts and welcome messages in multiple languages
Post-call analytics and reporting configurations

Here is my suggested revision broken into two paragraphs:

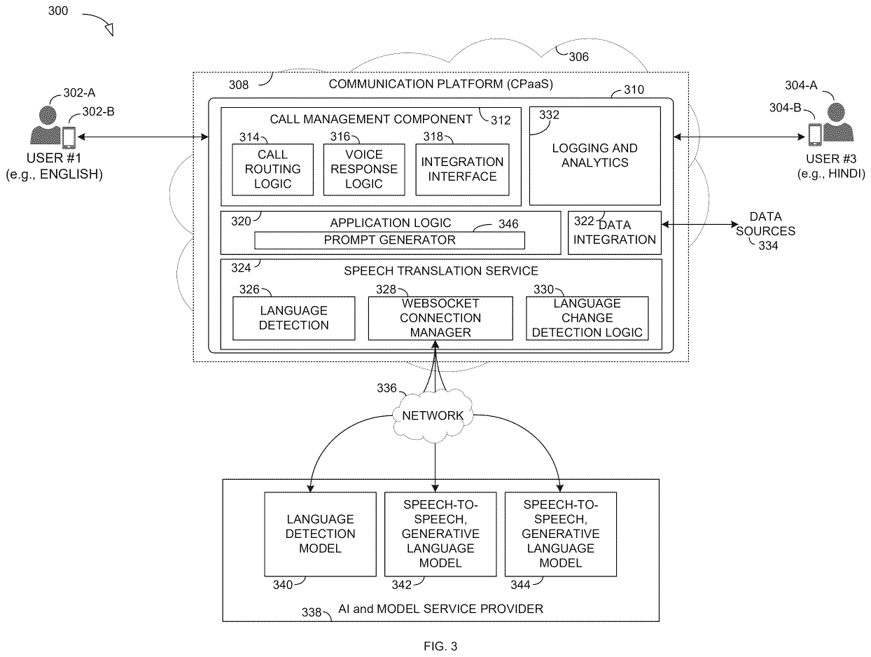

FIG. 3 illustrates a system 300 that includes a cloud-based communications application 310 hosted by a communications platform as a service (CPaaS) 308 implemented using cloud computing resources 306. The communications application 310 represents one example implementation that orchestrates real-time speech translation through specialized components including call management services, speech translation capabilities, and data integration features. While the illustrated components represent one possible configuration, the actual organization and distribution of functionality between components may vary across different implementations based on specific requirements, with certain features being combined or separated according to factors such as scalability needs, performance optimization, development choices, and integration requirements. Additionally, implementations may include a subset of the illustrated features and components, with varying degrees of configurability available to business customers depending on their specific needs and use cases.

Although the illustrated embodiment shows the communications application 310 implemented using cloud computing resources 306, in alternative embodiments, the application and its components may be implemented using conventional server infrastructure accessible via the Internet. Such implementations may utilize traditional server hardware and networking equipment to host the various services, including the application logic 320, call management service 312, speech translation service 324, and associated integration features, while maintaining the same functional capabilities and workflows for real-time translation between users speaking different languages. The system 300 facilitates real-time translation between a first user 302-A using device 302-B and a second user 304-A using device 304-B through the coordinated operation of these components, regardless of the specific infrastructure used to host the application. The extent to which specific features and components are implemented and made configurable may be tailored to meet different business requirements, from basic translation services to fully customizable enterprise solutions.

The call management component 312 handles incoming and outgoing calls through three primary subcomponents: call routing logic 314 that determines how calls are directed based on language capabilities, availability, and other factors, voice response logic 316 that manages automated voice prompts and user interactions, and an integration interface 318 that connects with external systems. These components work together to establish and maintain the communication channels between users while coordinating with the translation services.

Consistent with some embodiments, the call routing logic 314 operates in conjunction with the data integration component 322 to intelligently route incoming calls based on contextual information. In its simplest implementation, the call routing logic may simply connect the incoming call to the dialed number without additional processing. However, in more sophisticated implementations, the call routing logic works with data integration 322 to access customer profiles from data sources 334, which may include customer relationship management systems or customer data platforms, to enable intelligent routing decisions.

When receiving an incoming call, the system may attempt to match the caller with a recipient who speaks the same language, potentially avoiding the need for translation services altogether. This language-based routing is accomplished by analyzing the caller's profile data, historical interactions, and known language preferences stored in the customer profile. However, if no agents speaking the caller's language are available, or if insufficient profile data exists to confidently determine language matching, the system will proceed with translation-enabled routing.

For example, based on a customer's profile and interaction history, the system can route calls to specific enterprise departments or agents with appropriate language capabilities and expertise. When language-matched routing is not possible due to availability constraints or data limitations, the call routing logic will engage the translation services while still considering other routing factors such as department expertise, time zones, and agent availability to optimize the overall customer experience.

The voice response logic 316 provides programmable interactive voice response capabilities that work in coordination with the application logic 320. This component manages automated voice prompts and can collect user input through multiple channels, including DTMF (touch-tone) signals or voice commands processed through real-time audio stream analysis. The voice response logic 316 includes both pre-configured welcome messages explaining the translation service functionality, as well as dynamic prompts that adapt based on real-time language detection and selection. For example, when a user initiates a call, the system may play a predetermined message stating “Your call will be translated by an AI assistant,” followed by dynamically generated prompts that reference specific detected or selected languages, such as “The system will translate between Hindi and English.” The voice response logic coordinates with the application logic 320 to determine appropriate timing and content of these prompts, ensuring users understand the translation service's operation while maintaining natural conversation flow.

The integration interface 318 enables the communications application to connect with diverse communication infrastructure and endpoints. This component supports integration with traditional Public Switched Telephone Network (PSTN) systems, Voice over IP (VoIP) networks, Session Initiation Protocol (SIP) trunking services, and WebRTC-enabled browsers. The interface handles various audio codecs and provides necessary transcoding capabilities to ensure compatibility across different network types. It supports secure WebSocket connections for real-time media streaming, encrypted media transport through SRTP protocols, and can integrate with enterprise PBX systems through SIP trunking. This comprehensive integration capability allows the application to maintain broad accessibility while supporting both traditional telephony and modern internet-based communication channels.

Consistent with some embodiments, the application logic 320 implements the translation workflow and includes a prompt generator 346 that creates specialized prompts using configurable prompt templates and language-specific examples. These prompts are important for ensuring the speech-to-speech generative language models 342 and 344 perform pure translation rather than interpretation.

In some embodiments, the prompt generator 346 creates a system prompt or preamble containing the translation instruction that persists across the entire bid-directional communication session. This approach maintains the translation directive within the context window of the model throughout the conversation, preventing the model from reverting to interpretive behavior.

However, in implementations where the generative language model employs a rolling or sliding context window, there exists a risk that the translation instruction may eventually be pushed out of the context as new conversation tokens accumulate. When this occurs, the model may revert to its default behavior of generating interpretive responses rather than performing direct translation. To address this limitation, the application logic 320 implements a token tracking system that monitors the volume of tokens processed by a generative language model. The system maintains a running tally of generated tokens and based on the known context window size of the model, calculates when the original instruction is likely to be pushed out of context. At predetermined intervals, before the instruction would be lost, the prompt generator 346 automatically generates and sends a new prompt to the model, ensuring the translation directive remains active. This dynamic prompt refresh mechanism maintains consistent translation behavior throughout the conversation while optimizing the use of the context window of the model.

Consistent with some embodiments, the data integration component 322 connects to one or more external data sources 334 to access and leverage a rich set of contextual information that enhances the translation service's capabilities. Through this component, the communications application retrieves and processes customer profiles containing preferred languages, historical interaction patterns, regional settings, and communication preferences. In some embodiments, the integration extends beyond basic profile data to include detailed interaction histories, such as previous language selections, common phrases used, and specific terminology preferences that help optimize translation accuracy.

For enterprise deployments, the data integration component may interface with customer relationship management (CRM) systems, customer data platforms (CDP), and other business systems to build comprehensive user contexts. This integration enables sophisticated features such as department-specific routing based on past interactions, time zone-aware scheduling, and agent matching based on language proficiency and expertise. The system can also track and store translation quality metrics and user feedback to continuously improve service delivery.

The data integration capabilities support real-time decision making by providing immediate access to relevant customer data when calls are initiated. For example, when a customer calls, the system can instantly retrieve their language preferences, previous interaction history, and any special handling requirements. This information is used to optimize routing decisions, select appropriate translation models, and configure translation parameters to deliver a more personalized and effective communication experience. The integration component maintains secure connections to these external data sources while ensuring data privacy and compliance with relevant regulations and standards.

Consistent with some embodiments, the speech translation service 324 coordinates real-time translation through three specialized components: language detection 326 that identifies each speakers'language, WebSocket connection manager 328 that maintains low-latency connections with AI models, and language change detection logic 330 that monitors for mid-conversation language switches. The WebSocket connection manager 328 interfaces through network 336 with the AI and model service provider 338, which hosts multiple specialized models including a language detection model 340 and speech-to-speech generative language models 342, 344.

Consistent with some embodiments, the logging and analytics component 332 captures detailed metrics about each translation session, including confidence scores, translation quality measurements, and conversation analytics. This data enables continuous improvement of the translation service while providing valuable insights for post-call analysis.

With some embodiments, the language detection module 326 works in conjunction with the speech-to-speech generative language models to monitor and detect language changes during conversations. When processing audio data, the generative language model returns not only the translated audio output but also a text-based log corresponding to the translation and a confidence score representing the quality metric of the translation.

The language detection module 326 continuously monitors these confidence scores and text logs. A sudden decrease (or increase, depending on implementation) in the confidence score may indicate that a user has switched to speaking a different language. When such a change is detected, the language detection module 326 routes the audio data to the specialized language detection model 340 hosted by the AI and model service provider 338.

If the language detection model 340 confirms that the audio data contains speech in a language different from the originally detected or selected language, the WebSocket connection manager 328 establishes a new WebSocket connection with a different instance of the speech-to-speech generative language model. The audio stream is then redirected to this new model instance, which is configured specifically for translation between the newly detected language pair.

Through this dynamic monitoring and switching capability, the system maintains accurate translation even when users change languages mid-conversation, without requiring manual intervention or reconfiguration. The combination of confidence score monitoring, specialized language detection, and automated model switching ensures continuous, high-quality translation service throughout the conversation.

Through this integrated architecture, the communications application 310 orchestrates complex real-time translation workflows while maintaining low latency and high accuracy. The system's modular design enables customization for different use cases while leveraging the robust infrastructure of the cloud-based communications platform. The application's sophisticated prompt management, language detection, and context awareness capabilities overcome the traditional challenges of using speech-to-speech models for pure translation rather than interpretation.

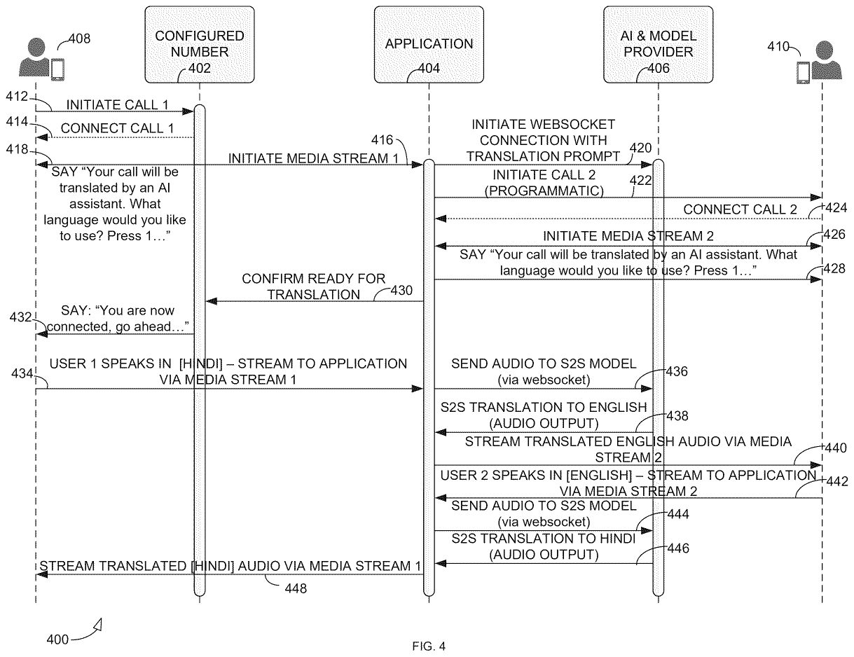

FIG. 4 illustrates, in accordance with some embodiments, a sequence diagram 400 showing the interaction flow between end-user devices 408 and 410, a communications application 404, and machine learning models of an AI model provider 406 for establishing and managing real-time translated conversations between users speaking different languages. The sequence diagram illustrates the interaction between two users speaking different languages facilitated via a first user device 408 and a second user device 410, mediated through three key components: a phone number configuration service 402, the cloud-hosted communications application 404, and one or more speech-to-speech generative language models—in this example, hosted by an AI & Model Provider 406.

The sequence begins when the user device 408 initiates a call—“INITIATE CALL 1” 412 to a configured phone number. This may happen as a result of the user specifying a specific phone number and then placing the call to that number or simply selecting a preconfigured button via a user interface of an application that is programmed to place a call to a specific number upon selection. In either case, upon receiving this initial call, the configured number service 402 establishes the connection, “CONNECT CALL 1” 414, and then initiates a media stream, “INITIATE MEDIA STREAM 1” 416 to facilitate bi-direction communication of audio data between the user device 408 and the application 404.

In some examples, and as illustrated in FIG. 4, the system then plays an automated message to the caller: “Your call will be translated by an AI Assistant. What language would you like to use? Press 1 for . . . ” 418. This interactive voice response allows the system to identify the caller's preferred language before proceeding with the translation service.

In alternative embodiments, the communications application 404 may determine the user's preferred or spoken language through several automated mechanisms without requiring explicit language selection through an IVR system. In one implementation, the application may access a customer profile associated with the calling phone number or user account from which the call originated, where the profile contains a preferred language field indicating the user's language preference. The customer profile may be retrieved through data integration services that connect to customer relationship management systems or other data sources containing user language preferences. In another implementation, the communications application may employ automated language detection, wherein initial audio data from the user is routed through a specialized language detection model that has been trained to identify the language being spoken. In some embodiments, this language detection capability may be implemented through a dedicated language detection component that works in conjunction with the WebSocket connection manager to analyze incoming audio streams in real-time, enabling the system to automatically configure appropriate translation services for the detected language without requiring manual selection.

After determining the preferred language of the first user, using the first user device 408, the communications application 404 initiates a WebSocket connection with the AI and model provider 406 at step 420, in some cases, transmitting a specialized translation prompt that configures the speech-to-speech generative language model for pure translation rather than interpretation. The prompt includes language-specific examples and instructions to ensure the model maintains translation mode throughout the conversation.

With some embodiments, the communications application 404 includes a prompt generator that creates specialized prompts using configurable prompt templates and language-specific examples. The prompt generator accesses a prompt template that includes placeholders for language identifiers and example text. When generating a prompt, the system retrieves language-specific example text corresponding to the detected or selected languages for the conversation participants. The prompt generator then populates the prompt template with the appropriate language identifiers in the placeholders, along with the retrieved language-specific examples that demonstrate correct translation between the language pair.

For example, when configuring a Hindi-to-English translation session, the prompt generator retrieves examples showing Hindi phrases and their proper English translations. These examples are carefully selected to demonstrate pure translation rather than interpretation, helping to train the model to maintain fidelity to the original speech. The prompt generator dynamically updates these examples based on the specific language pair and conversation context, ensuring the speech-to-speech model maintains translation mode throughout the session. This template-based approach enables consistent prompt generation while allowing customization for different language pairs and use cases.

In parallel with operation 420, at step 422, the communications application 404 programmatically initiates a second call, “INITIATE CALL 2” 422 to connect with the second user device 410. This second call may be directed to a specific phone number associated with the called party, or in some instances, such as in the context of a contact center service or customer support service, may be routed to the user device 410 according to the routing logic of the application 404 based on factors such as agent language capabilities, availability, and time zones. Upon successful connection, “CONNECT CALL 2” at step 424, the application establishes a second media stream, “INITIATE MEDIA STREAM 2”, at step 426 to facilitate bidirectional audio communication with the second user.

The system then plays an automated message at step 428 to the second user: “Your call will be translated by an AI assistant. What language would you like to use? Press 1 . . . ” This message, similar to the one played for the first user, enables language selection for the second participant, though as previously described, the language may alternatively be determined through automated detection or profile lookup. Once both users have confirmed their readiness for translation at step 430, the system enables real-time bidirectional translation through the established media streams and WebSocket connections.

At step 432, after both users have confirmed their readiness for translation, the communications application 404 triggers an integrated voice response unit to play a message to the first user via user device 408 stating “You are now connected, go ahead . . . ” This message indicates that the bidirectional translation service is ready to begin processing speech from either participant.

Following this prompt, at step 434, the first user begins speaking in Hindi, with the audio data streaming to the communications application 404 via media stream 1. The application 404 processes this incoming audio stream using sophisticated chunking logic that identifies natural breaks in speech, such as pauses between sentences or phrases. This intelligent chunking ensures optimal processing of the audio data before transmission to the speech-to-speech generative language model.

At step 436, the communications application 404 forwards these audio chunks via the established WebSocket connection to the speech-to-speech generative language model hosted by the AI and model provider 406. The model processes these chunks and generates translated audio output in English at step 438. The application's chunking logic monitors the audio stream for natural pauses and silence periods to determine appropriate segment boundaries, helping maintain conversation flow while ensuring accurate translation. This approach allows the system to balance the need for immediate translation with maintaining context and meaning across sentence boundaries.

At step 440, the communications application 404 streams the translated English audio data received from the speech-to-speech generative language model via media stream 2 to the second user device 410. While the first user continues speaking in Hindi, the synthesized English speech is played in real-time to the second user through the established media stream connection.

The bidirectional translation continues at step 442, where the second user speaks in English, with this audio data streaming back to the communications application 404 via media stream 2. The application processes this incoming English audio stream using its chunking logic to identify natural breaks in speech. At step 444, the communications application 404 transmits these audio chunks through a second WebSocket connection to another instance of the speech-to-speech generative language model hosted by the AI model provider 406. This second model instance is specifically configured through its own translation prompt to translate from English to Hindi, enabling natural bidirectional conversation flow between the participants.

At step 446, the speech-to-speech generative language model hosted by the AI model provider 406 generates translated Hindi audio output from the English speech input. The communications application 404 then streams this translated Hindi audio via media stream 1 back to the first user device 408 at step 448, enabling the first user to hear the second user's English speech as Hindi audio. This bidirectional translation process continues throughout the duration of the call, with each user speaking in their preferred language while hearing the other party's speech translated in real-time to their own language through the parallel media streams and WebSocket connections.

In some embodiments, the communications application 404 may be configured to operate in a “mixed audio” mode where the original speech from a user is first played to the other participant, followed immediately by the translated version. For example, when User 1 speaks in Hindi, their original Hindi audio would be streamed to User 2 via media stream 2, followed by the English translation generated by the speech-to-speech model. This configuration allows participants to hear both the emotional tone and cadence of the original speaker while also receiving the translated, synthesized content.

Alternatively, the communications application may be configured to operate in a “translation-only” mode where participants hear only the translated version of the other party's speech. In this configuration, when User 1 speaks in Hindi, only the English translation would be streamed to User 2, and when User 2 speaks in English, only the Hindi translation would be streamed to User 1. This mode may be preferred in scenarios that call for minimizing confusion or reducing cognitive load is important, such as in customer service interactions or emergency situations.

The choice between these operating modes can be configured through the application's business logic components, allowing organizations to select the most appropriate mode based on their specific use case, user preferences, or regulatory requirements. The configuration may be set globally for all calls handled by a particular instance of the communications application 404 or dynamically selected based on factors such as call type, user profiles, or specific routing rules.

The architecture and techniques described provide several significant advantages over conventional approaches to real-time language translation. The system's specialized prompt engineering and template-based approach ensures pure translation rather than interpretive responses from the language models, solving a fundamental challenge in using these models for translation purposes. Through dynamic prompt updates and language-specific examples, the system maintains translation mode throughout conversations, preventing the model from reverting to interpretation mode which would otherwise disrupt natural communication flow.

The direct speech-to-speech translation capabilities eliminate the traditional multi-step process of speech-to-text-to-speech conversion, while intelligent chunking of audio streams and parallel processing through WebSocket connections enables real-time conversation flow with minimal latency. The system's optimized audio stream processing maintains low latency while preserving translation accuracy, addressing a critical technical challenge in real-time communication.

The implementation of automated language detection eliminates manual configuration requirements, while real-time confidence scoring enables dynamic language switching during conversations. This sophisticated monitoring system continuously evaluates translation quality and allows immediate adjustment of language pairs when needed, providing flexibility not available in conventional systems.

Integration with customer profiles and historical data enhances translation accuracy, while contextual routing based on language capabilities, time zones, and availability improves the overall user experience. The system's sophisticated logging and analytics capabilities enable post-call analysis and continuous improvement of the translation service.

The architecture provides broad accessibility through support for multiple communication channels including PSTN and VoIP, requiring no specialized endpoint software for users. The cloud-based infrastructure enables flexible deployment options and a multi-tenant architecture that supports customization for different business needs. Advanced integration capabilities allow seamless connection with existing telephony infrastructure, customer relationship management systems, and multiple AI model providers, while providing comprehensive real-time analytics and monitoring capabilities.

### Software Architecture

FIG. 7 is a block diagram 700 illustrating a software architecture 702, which can be installed on any one or more of the devices described herein. The software architecture 702 is supported by hardware such as a machine 804 that includes processors 806, memory 808, and I/O components 810. In this example, the software architecture 702 can be conceptualized as a stack of layers, where each layer provides a particular functionality. The software architecture 702 includes layers such as an operating system 712, libraries 714, frameworks 716, and applications 718. Operationally, the applications 718 invoke API calls 720 through the software stack and receive messages 722 in response to the API calls 720.

The operating system 712 manages hardware resources and provides common services. The operating system 712 includes, for example, a kernel 724, services 726, and drivers 728. The kernel 724 acts as an abstraction layer between the hardware and the other software layers. For example, the kernel 724 provides memory management, processor management (e.g., scheduling), component management, networking, and security settings, among other functionalities. The services 726 can provide other common services for the other software layers. The drivers 728 are responsible for controlling or interfacing with the underlying hardware. For instance, the drivers 728 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 714 provide a common low-level infrastructure used by the applications 718. The libraries 714 can include system libraries 730 (e.g., C standard library) that provide functions such as memory allocation functions, string manipulation functions, mathematical functions, and the like. In addition, the libraries 714 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 714 can also include a wide variety of other libraries 734 to provide many other APIs to the applications 718.

The frameworks 716 provide a common high-level infrastructure that is used by the applications 718. For example, the frameworks 716 provide various graphical user interface (GUI) functions, high-level resource management, and high-level location services. The frameworks 716 can provide a broad spectrum of other APIs that can be used by the applications 718, some of which may be specific to a particular operating system or platform.

In an example, the applications 718 may include a home application 736, a contacts application 738, a browser application 740, a book reader application 742, a location application 744, a media application 746, a messaging application 748, a game application 750, and a broad assortment of other applications such as a third-party application 752. The applications 718 are programs that execute functions defined in the programs. Various programming languages can be employed to create one or more of the applications 718, structured in a variety of manners, such as object-oriented programming languages (e.g., Objective-C, Java, or C++) or procedural programming languages (e.g., C or assembly language). In a specific example, the third-party application 752 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 752 can invoke the API calls 720 provided by the operating system 712 to facilitate functionalities described herein.

### Machine Architecture

FIG. 8 is a diagrammatic representation of the machine 800 within which instructions 802 (e.g., software, a program, an application, an applet, an app, or other executable code) for causing the machine 800 to perform any one or more of the methodologies discussed herein may be executed. For example, the instructions 802 may cause the machine 800 to execute any one or more of the methods described herein. The instructions 802 transform the general, non-programmed machine 800 into a particular machine 800 programmed to carry out the described and illustrated functions in the manner described. The machine 800 may operate as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 802, sequentially or otherwise, that specify actions to be taken by the machine 800. Further, while a single machine 800 is illustrated, the term machine” shall also be taken to include a collection of machines that individually or jointly execute the instructions 802 to perform any one or more of the methodologies discussed herein. The machine 800, for example, may comprise the user device or any one of multiple server devices forming part of a server system. In some examples, the machine 800 may also comprise both client and server systems, with certain operations of a particular method or algorithm being performed on the server-side and with certain operations of the method or algorithm being performed on the client-side.

The machine 800 may include processors 804, memory 804, and input/output I/O components 808, which may be configured to communicate with each other via a bus 810.

The memory 806 includes a main memory 816, a static memory 818, and a storage unit 820, both accessible to the processors 804 via the bus 810. The main memory 806, the static memory 818, and storage unit 820 store the instructions 802 embodying any one or more of the methodologies or functions described herein. The instructions 802 may also reside, completely or partially, within the main memory 816, within the static memory 818, within machine-readable medium 822 within the storage unit 820, within at least one of the processors 804 (e.g., within the processor's cache memory), or any suitable combination thereof, during execution thereof by the machine 800.

The I/O components 808 may include a wide variety of components to receive input, provide output, produce output, transmit information, exchange information, capture measurements, and so on. The specific I/O components 808 that are included in a particular machine will depend on the type of machine. For example, portable machines such as mobile phones may include a touch input device or other such input mechanisms, while a headless server machine will likely not include such a touch input device. It will be appreciated that the I/O components 808 may include many other components that are not shown in FIG. 8. In various examples, the I/O components 808 may include user output components 624 and user input components 826. The user output components 824 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 826 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

The motion components 830 include acceleration sensor components (e.g., accelerometer), gravitation sensor components, rotation sensor components (e.g., gyroscope).

The environmental components 832 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

Communication may be implemented using a wide variety of technologies. The I/O components 608 further include communication components 636 operable to couple the machine 600 to a network 638 or devices 640 via respective coupling or connections. For example, the communication components 636 may include a network interface component or another suitable device to interface with the network 638. In further examples, the communication components 636 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 640 may be another machine or any of a wide variety of peripheral devices (e.g., a peripheral device coupled via a USB).

Moreover, the communication components 836 may detect identifiers or include components operable to detect identifiers. For example, the communication components 836 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 836, such as location via Internet Protocol (IP) geolocation, location via Wi-Fi® signal triangulation, location via detecting an NFC beacon signal that may indicate a particular location, and so forth.

The various memories (e.g., main memory 816, static memory 818, and memory of the processors 804) and storage unit 820 may store one or more sets of instructions and data structures (e.g., software) embodying or used by any one or more of the methodologies or functions described herein. These instructions (e.g., the instructions 802), when executed by processors 804, cause various operations to implement the disclosed examples.

The instructions 802 may be transmitted or received over the network 838, using a transmission medium, via a network interface device (e.g., a network interface component included in the communication components 836) and using any one of several well-known transfer protocols (e.g., hypertext transfer protocol (HTTP)). Similarly, the instructions 602 may be transmitted or received using a transmission medium via a coupling (e.g., a peer-to-peer coupling) to the devices 840.

What is claimed, is:

1. A method performed by a cloud-based communications application for facilitating language translated communications, the method comprising:
receiving a first call initiated by a first user device of a first user;
establishing a first media stream connection with the first user device associated with the first call;
initiating a second call to connect with a second user device of a second user;
establishing a second media stream connection with the second user device associated with the second call;
establishing a first WebSocket connection with a first instance of a speech-to-speech generative language model;
receiving, via the first media stream connection, first audio data comprising speech in a first language from the first user;
transmitting, via the first WebSocket connection, the first audio data to the first instance of the speech-to-speech generative language model for translation to a second language;
receiving, from the first instance of the speech-to-speech generative language model, first translated audio data comprising the speech translated to the second language; and
streaming, via the second media stream connection, the first translated audio data to the second user device.

2. The method of claim 1, further comprising:
receiving, via the second media stream connection, second audio data comprising speech in the second language from the second user;
establishing a second WebSocket connection with a second instance of the speech-to-speech generative language model;
transmitting, via the second WebSocket connection, the second audio data to the second instance of the speech-to-speech generative language model for translation to the first language;
receiving, from the second instance of the speech-to-speech language model, second translated audio data comprising the speech translated to the first language; and
streaming, via the first media stream connection, the second translated audio data to the first user device.

3. The method of claim 1, further comprising:
transmitting, to the first instance of the speech-to-speech generative language model via the first WebSocket connection, a text-based prompt comprising instructions directing the first instance of the speech-to-speech generative language model to translate audio data representing speech in the first language to audio data representing speech in the second language, wherein the text-based prompt includes at least one example of text in the first language and a corresponding translation of that text in the second language.

4. The method of claim 3, wherein the text-based prompt is generated by the cloud-based communications application by:
accessing a prompt template that includes a placeholder for a language identifier;
detecting or receiving a selection of the first language;
retrieving language-specific example text corresponding to the first language and the second language; and
populating the prompt template with an identifier of the first language in the placeholder, and the retrieved language-specific example text.

5. The method of claim 1, wherein the first language is determined by least one of:
automatically detecting the first language using a language detection model analyzing the first audio data;
prompting, via an interactive voice response system, the first user to select the first language from a plurality of available languages; or
accessing a customer profile associated with a phone number of the first user device to determine a preferred language associated with the first user.

6. The method of claim 2, wherein the second language is determined by at least one of:
automatically detecting the second language using a language detection model analyzing the second audio data;
prompting, via an interactive voice response system, the second user to select the second language from a plurality of available languages;
accessing a customer profile associated with a phone number of the second user device to determine a preferred language associated with the second user; or
determining the second language based on configuration settings associated with a phone number used to initiate the first call.

7. The method of claim 1, further comprising:
receiving, from the first instance of the speech-to-speech generative language model in response to transmitting the first audio data i) the first translated audio data, ii) a text-based log corresponding to the first translated audio data, and iii) a confidence score representing a quality metric of the translation;
determining that the confidence score transgresses a threshold value;
in response to determining that the confidence score transgresses the threshold value:
routing the first audio data to a language detection model,
detecting, by the language detection model, that the first audio data comprises speech in a third language different from the first language,
establishing a third WebSocket connection with a third instance of the speech-to-speech generative language model, and
transmitting, via the third WebSocket connection, the first audio data to the third instance of the speech-to-speech generative language model for translation from the third language to the second language.

8. A system for facilitating language translated communications, the system comprising:
at least one processor; and
at least one memory storage device storing thereon instructions, which, when executed by the at least one processor, cause the system to perform operations comprising:
receiving a first call initiated by a first user device of a first user;
establishing a first media stream connection with the first user device associated with the first call;
initiating a second call to connect with a second user device of a second user;
establishing a second media stream connection with the second user device associated with the second call;
establishing a first WebSocket connection with a first instance of a speech-to-speech generative language model;
receiving, via the first media stream connection, first audio data comprising speech in a first language from the first user;
transmitting, via the first WebSocket connection, the first audio data to the first instance of the speech-to-speech generative language model for translation to a second language;
receiving, from the first instance of the speech-to-speech generative language model, first translated audio data comprising the speech translated to the second language; and
streaming, via the second media stream connection, the first translated audio data to the second user device.

9. The system of claim 8, wherein the at least one memory storage device is storing further instructions, which, when executed by the at least one processor, cause the system to perform further operations comprising:
receiving, via the second media stream connection, second audio data comprising speech in the second language from the second user;
establishing a second WebSocket connection with a second instance of the speech-to-speech generative language model;
transmitting, via the second WebSocket connection, the second audio data to the second instance of the speech-to-speech generative language model for translation to the first language;
receiving, from the second instance of the speech-to-speech generative language model, second translated audio data comprising the speech translated to the first language; and
streaming, via the first media stream connection, the second translated audio data to the first user device.

10. The system of claim 8, wherein the at least one memory storage device is storing further instructions, which, when executed by the at least one processor, cause the system to perform further operations comprising:
transmitting, to the first instance of the speech-to-speech generative language model via the first WebSocket connection, a text-based prompt comprising instructions directing the first instance of the speech-to-speech generative language model to translate audio data representing speech in the first language to audio data representing speech in the second language, wherein the text-based prompt includes at least one example of text in the first language and a corresponding translation of that text in the second language.

11. The system of claim 10, wherein the text-based prompt is generated by system, by:
accessing a prompt template that includes a placeholder for a language identifier;
detecting or receiving a selection of the first language;
retrieving language-specific example text corresponding to the first language and the second language; and
populating the prompt template with an identifier of the first language in the placeholder, and the retrieved language-specific example text.

12. The system of claim 8, wherein the first language is determined by least one of:
automatically detecting the first language using a language detection model analyzing the first audio data;
prompting, via an interactive voice response system, the first user to select the first language from a plurality of available languages; or
accessing a customer profile associated with a phone number of the first user device to determine a preferred language associated with the first user.

13. The system of claim 9, wherein the second language is determined by at least one of:
automatically detecting the second language using a language detection model analyzing the second audio data;
prompting, via an interactive voice response system, the second user to select the second language from a plurality of available languages;
accessing a customer profile associated with a phone number of the second user device to determine a preferred language associated with the second user; or
determining the second language based on configuration settings associated with a phone number used to initiate the first call.

14. The system of claim 10, wherein the at least one memory storage device is storing further instructions, which, when executed by the at least one processor, cause the system to perform further operations comprising:
receiving, from the first instance of the speech-to-speech generative language model in response to transmitting the first audio data i) the first translated audio data, ii) a text-based log corresponding to the first translated audio data, and iii) a confidence score representing a quality metric of the translation;
determining that the confidence score transgresses a threshold value;
in response to determining that the confidence score transgresses the threshold value:
routing the first audio data to a language detection model,
detecting, by the language detection model, that the first audio data comprises speech in a third language different from the first language,
establishing a third WebSocket connection with a third instance of the speech-to-speech generative language model, and
transmitting, via the third WebSocket connection, the first audio data to the third instance of the speech-to-speech generative language model for translation from the third language to the second language.

15. A computer-readable medium storing instructions thereon, which, when executed by one or more processors of a computing system, cause the computing system to perform operations comprising:
receiving a first call initiated by a first user device of a first user;
establishing a first media stream connection with the first user device associated with the first call;
initiating a second call to connect with a second user device of a second user;
establishing a second media stream connection with the second user device associated with the second call;
establishing a first WebSocket connection with a first instance of a speech-to-speech generative language model;
receiving, via the first media stream connection, first audio data comprising speech in a first language from the first user;
transmitting, via the first WebSocket connection, the first audio data to the first instance of the speech-to-speech generative language model for translation to a second language;
receiving, from the first instance of the speech-to-speech generative language model, first translated audio data comprising the speech translated to the second language; and
streaming, via the second media stream connection, the first translated audio data to the second user device.

16. The computer-readable medium of claim 15, wherein the instructions, when executed by the one or more processors of the computing system, cause the computing system to perform operations comprising:
receiving, via the second media stream connection, second audio data comprising speech in the second language from the second user;
establishing a second WebSocket connection with a second instance of the speech-to-speech generative language model;
transmitting, via the second WebSocket connection, the second audio data to the second instance of the speech-to-speech generative language model for translation to the first language;
receiving, from the second instance of the speech-to-speech generative language model, second translated audio data comprising the speech translated to the first language; and
streaming, via the first media stream connection, the second translated audio data to the first user device.

17. The computer-readable medium of claim 15, wherein the instructions, when executed by the one or more processors of the computing system, cause the computing system to perform operations comprising:
transmitting, to the first instance of the speech-to-speech generative language model via the first WebSocket connection, a text-based prompt comprising instructions directing the first instance of the speech-to-speech generative language model to translate audio data representing speech in the first language to audio data representing speech in the second language, wherein the text-based prompt includes at least one example of text in the first language and a corresponding translation of that text in the second language.

18. The computer-readable medium of claim 17, wherein the text-based prompt is generated by the computing system, by:
accessing a prompt template that includes a placeholder for a language identifier;
detecting or receiving a selection of the first language;
retrieving language-specific example text corresponding to the first language and the second language; and
populating the prompt template with an identifier of the first language in the placeholder, and the retrieved language-specific example text.

19. The computer-readable medium of claim 16, wherein the first language is determined by least one of:
automatically detecting the first language using a language detection model analyzing the first audio data;
prompting, via an interactive voice response system, the first user to select the first language from a plurality of available languages; or
accessing a customer profile associated with a phone number of the first user device to determine a preferred language associated with the first user.

20. The computer-readable medium of claim 16, wherein the second language is determined by at least one of:
automatically detecting the second language using a language detection model analyzing the second audio data;
prompting, via an interactive voice response system, the second user to select the second language from a plurality of available languages;
accessing a customer profile associated with a phone number of the second user device to determine a preferred language associated with the second user; or
determining the second language based on configuration settings associated with a phone number used to initiate the first call.
